(19) United States
(12) Patent Application Publication
(10) Pub. No.: US 2023/0241780 A1
(43) Pub. Date: Aug. 3, 2023

(54) Robotic System And Robot Control Method

(71) Applicant: SEIKO EPSON CORPORATION, Tokyo (JP)

(72) Inventor: Katsutoyo INOUE, Azumino (JP)

(21) Appl. No.: 18/160,663

(22) Filed: Jan. 27, 2023

(30) Foreign Application Priority Data
Jan. 28, 2022 (JP) 2022-011728

(51) Int. Cl. B25J 9/16; B25J 13/08

(52) U.S. Cl. CPC B25J 9/1697; B25J 13/087; B25J 13/089; B25J 9/1641

(57) ABSTRACT

The robotic system includes a robotic arm; a shape information acquisition section acquiring shape information of an object, based on a time difference between time when laser beam is emitted by an light emitting section and time when reflected light is received by a light receiving section; an inertial sensor acquiring position information of the robotic arm during damped vibration when the moving robotic arm becomes stationary; and a control section identifying the position and posture of an object, based on shape information and position information, wherein the control section performs first control to identify a position and an posture of the object based on shape information and position information at a first time and shape information and position information at a second time after the first time during damped vibration of the robotic arm.

The present application is based on, and claims priority from JP Application Serial Number 2022-011728, filed Jan. 28, 2022, the disclosure of which is hereby incorporated by reference herein in its entirety.

### BACKGROUND

### 1. Technical Field

The present disclosure to a robotic system and a robot control method.

### 2. Related Art

In recent years, due to soaring labor costs and a shortage of human resources, factories have been accelerating the automation of tasks that have been performed manually, using robots with robotic arms. As shown in JP-A-2021-79538, for example, such a robot is equipped with a robotic arm, a recognition means for recognizing objects such as work objects, and a control section for controlling the drive of the robotic arm based on shape information of the objects recognized by the recognition means. JP-A-2021-79538 lists cameras, radar sensors, LiDAR sensors, ultrasonic sensors, infrared sensors, and the like, as the recognition means.

However, in the robotic system described in JP-A-2021-79538, after the robotic arm moves to a position where it can work on the work object, it waits there for the damped vibration to subside before recognizing the work objects with the above recognition means and performing the work. This increases the total operation time as it waits for the damped vibration to subside.

### SUMMARY

A robotic system of the present disclosure includes a robotic arm; a shape information acquisition section including a light emitting section, which emits a laser beam toward an object, and a light receiving section, which receives reflected light of the laser beam reflected by the object, the shape information acquisition section acquiring shape information of the object based on time difference between time when the laser beam is emitted by the emitting section and time when the reflected light is received by the light receiving section; an inertial sensor acquiring position information of the robotic arm during damped vibration when the moving robotic arm becomes stationary; and a control section identifying a position and a posture of the object based on the shape information and the position information, wherein the control section performs a first control to identify the position and the posture of the object during the damped vibration of the robotic arm, based on the shape information and the position information at a first time and the shape information and the position information at a second time after the first time.

A robot control method according to the present disclosure including the robot that includes a robotic arm; a shape information acquisition section including a light emitting section, which emits a laser beam toward an object, and a light receiving section, which receives reflected light of the laser beam reflected by the object, the shape information acquisition section acquiring shape information of the object based on time difference between time when the laser beam is emitted by the emitting section and time when the reflected light is received by the light receiving section; an inertial sensor acquiring position information of the robotic arm during damped vibration when the moving robotic arm becomes stationary; the robot control method executes a first control of identifying a position and a posture of the object, during damped vibration of the robotic arm, based on the shape information and the position information at a first time and the shape information and the position information at a second time after the first time.

### BRIEF DESCRIPTION OF THE DRAWINGS

FIG. 1 is a diagram showing an overall configuration of a robotic system according to the present disclosure.

FIG. 2 is a block diagram of the robotic system shown in FIG. 1.

FIG. 3 is a schematic diagram for explaining a state in which a shape information acquisition section of the robotic system shown in FIG. 1 is acquiring shape information.

FIG. 4 is an another schematic diagram for explaining a state in which the shape information acquisition section included in the robotic system shown in FIG. 1 acquires the shape information.

FIG. 5 is a graph showing velocity of a control point over time as the robotic arm shown in FIG. 1 moves.

FIG. 6 is a timing chart for comparing the background robotic system with the robot system of the present disclosure.

FIG. 7 is a diagram for explaining a state in which the shape information acquisition section shown in FIG. 1 acquires the shape information during damped vibration.

FIG. 8 is a diagram for explaining a position at which reflected light is received in the state shown in FIG. 7.

FIG. 9 is a diagram showing a composite of the images shown in FIG. 8.

FIG. 10 is a flowchart for explaining an example of a robot control method according to the present disclosure.

### DESCRIPTION OF EMBODIMENT

Hereinafter, a robotic system and a robot control method according to the present disclosure will be described in detail based on preferred embodiments shown in the accompanying drawings.

### EMBODIMENT

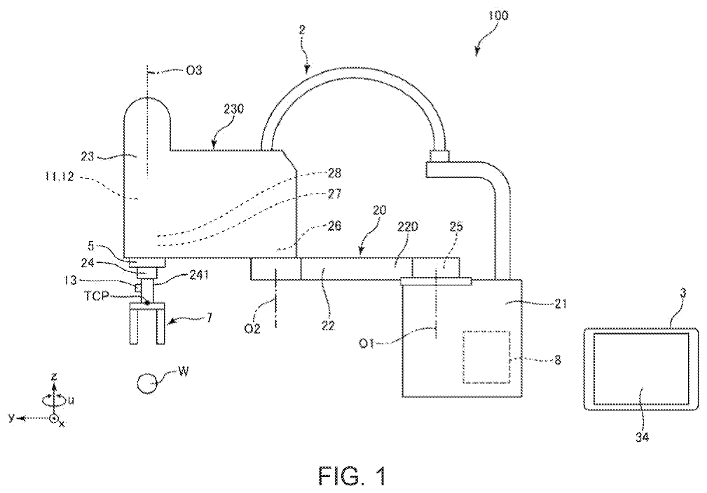

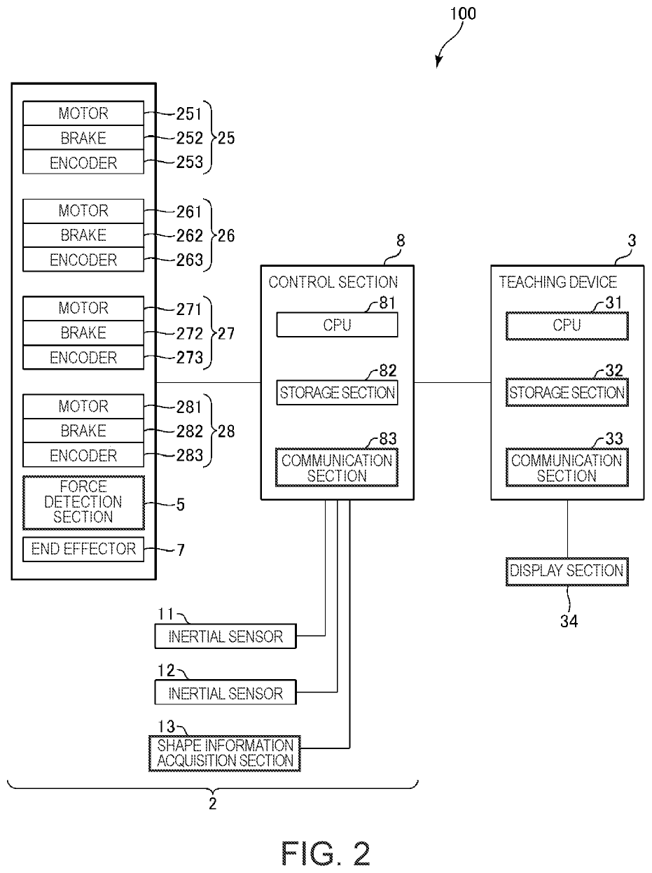

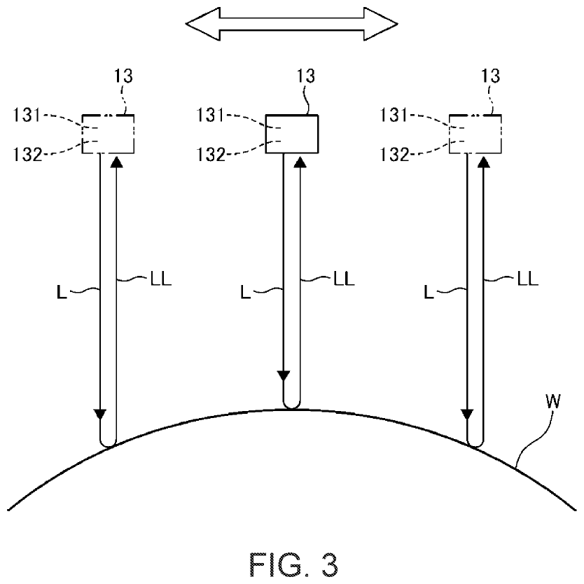

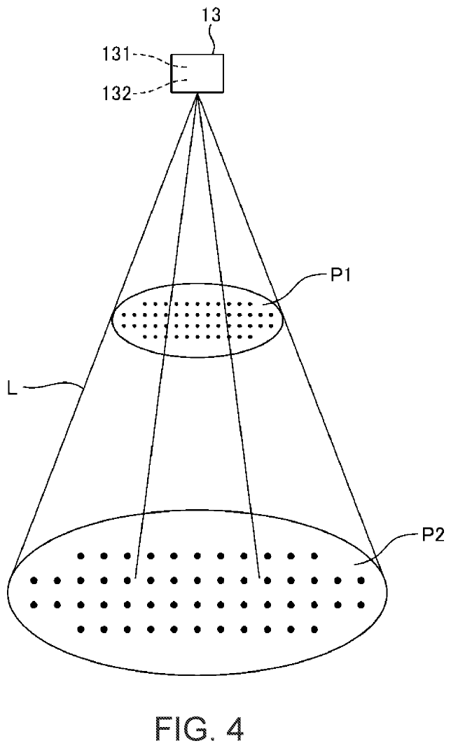

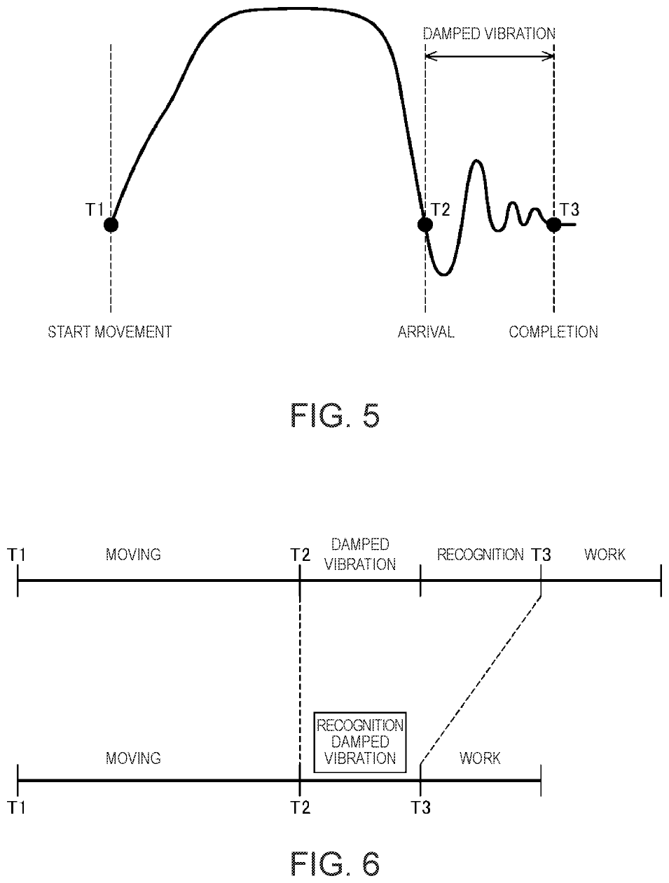

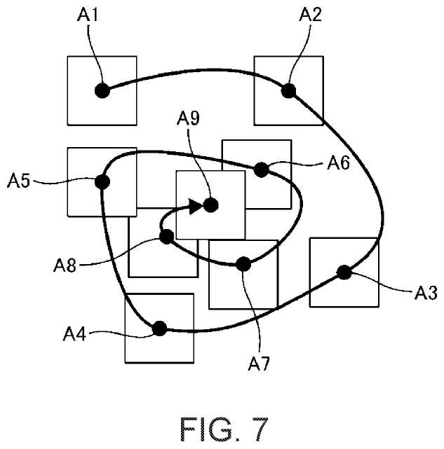

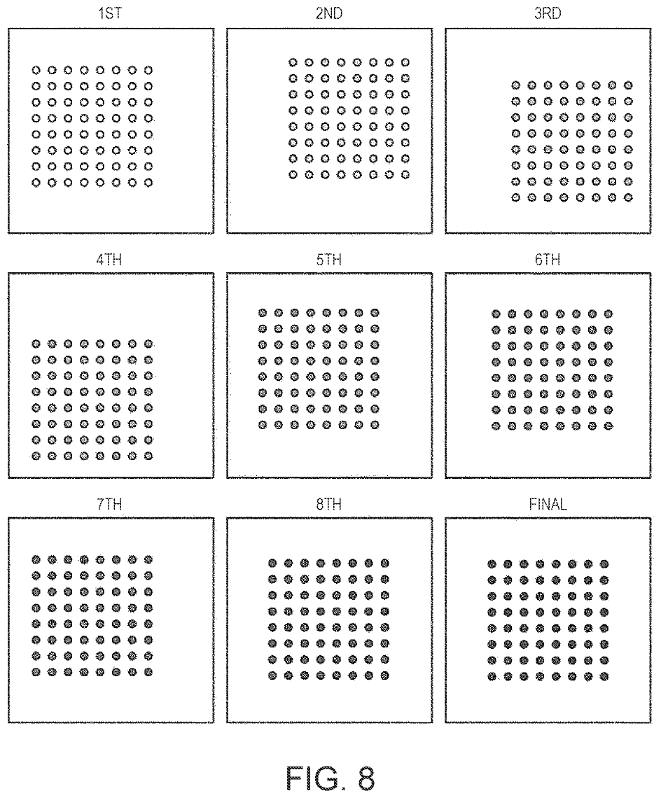

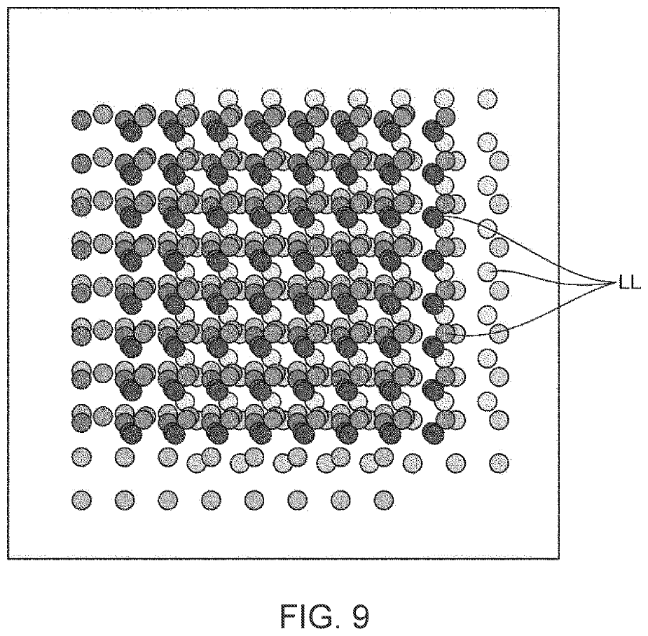

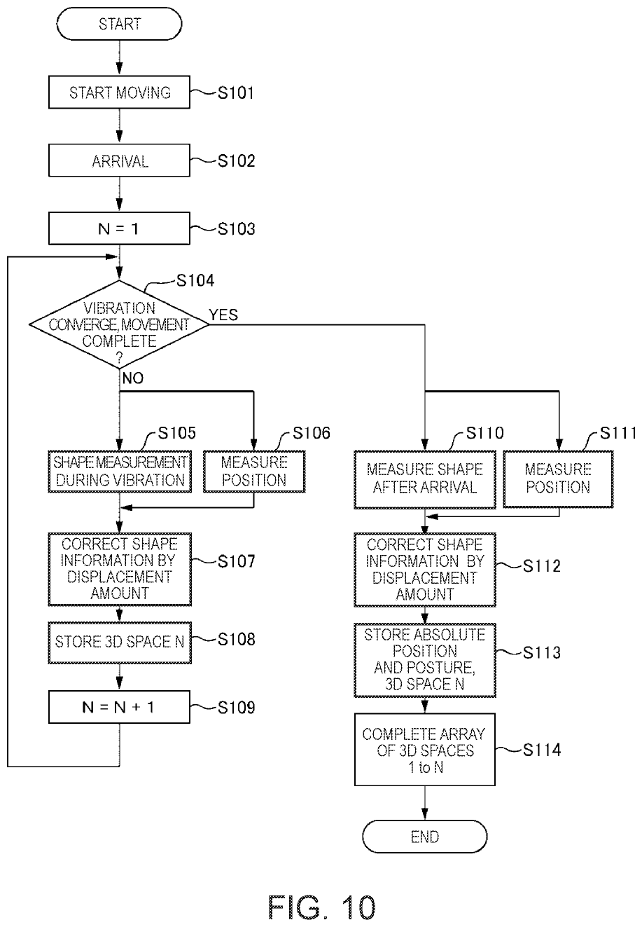

FIG. 1 is a diagram showing an overall configuration of a robotic system according to the present disclosure. FIG. 2 is a block diagram of the robotic system shown in FIG. 1. FIG. 3 is a schematic diagram for explaining a state in which a shape information acquisition section of the robotic system shown in FIG. 1 is acquiring shape information. FIG. 4 is an another schematic diagram for explaining a state in which the shape information acquisition section equipped with the robotic system shown in FIG. 1 is acquiring the shape information. FIG. 5 is a graph showing velocity of a control point over time as the robotic arm shown in FIG. 1 moves. FIG. 6 is a timing chart for comparing the background robotic system with the robot system of the present disclosure. FIG. 7 is a diagram for explaining a state in which the shape information acquisition section shown in FIG. 1 is acquiring the shape information during damped vibration. FIG. 8 is a diagram for explaining a position at which reflected light is received in the states shown in FIG. 7. FIG. 9 is a diagram showing a composite of the images shown in FIG. 8. FIG. 10 is a flowchart for explaining an example of a robot control method according to the present disclosure.

In FIG. 1, for convenience of explanation, an x-axis, a y-axis, and a z-axis are shown as three axes orthogonal to each other. Hereinafter, a direction parallel to the x-axis is also referred to as an “x-axis direction”, a direction parallel to the y-axis is also referred to as a “y-axis direction”, and a direction parallel to the z-axis is also referred to as a “z-axis direction”. The z-axis direction in FIG. 1, that is, an up-down direction is referred to as a “vertical direction”, and the x-axis direction and the y-axis direction, that is, left-right directions are referred to as “horizontal directions”. In addition, in each axis, a tip side is referred to as a “+ side”, and a base side is referred to as a “− side”.

A robotic system 100 shown in FIGS. 1 and 2 is an apparatus used in holding, transporting, assembling, and inspecting objects to be worked on, such as electronic components and electronic devices (hereinafter referred to as a “workpiece W”). The robotic system 100 includes a robot 2 and a teaching device 3 that teaches an operation program to the robot 2. The robot 2 and the teaching device 3 can communicate with each other by wire or wireless means.

First, the robot 2 will be described. The robot 2 is a horizontal articulated robot, that is, a SCARA robot, in the configuration shown in the figure. However, the robot 2 is not limited to this configuration, and may be an articulated robot such as a vertical six axis robot. As shown in FIG. 1, the robot 2 includes a base 21, a robotic arm 20 connected to the base 21, a force detection section 5, an end effector 7, an inertial sensor 11, an inertial sensor 12, a shape information acquisition section 13, and a control device 8 that controls operations of these sections.

The base 21 is a portion that supports the robotic arm 20. The control device 8, which will be described later, is built into the base 21. The origin of the robot coordinate system is set at any part of the base 21. The x-axis, the y-axis, the z-axis, and a u-axis shown in FIG. 1 are axes of the robot coordinate system.

The robotic arm 20 has a first arm 22, a second arm 23, and a third arm 24. The connection section between the base 21 and the first arm 22, the connection section between the first arm 22 and the second arm 23, and the connection section between the second arm 23 and the third arm 24 are also referred to as joints.

The robot 2 is not limited to the configuration shown in the figure, and the number of arms may be one or two, or four or more.

The robot 2 is also equipped with a drive section 25 that rotates the first arm 22 with respect to the base 21, a drive section 26 that rotates the second arm 23 with respect to the first arm 22, a u-drive section 27 that rotates a shaft 241 of the third arm 24 with respect to the second arm 23, and a z-drive section 28 that moves the shaft 241 in the z-axis direction with respect to the second arm 23.

As shown in FIGS. 1 and 2, the drive section 25 is built into the base 21, and includes a motor 251 that generates a driving force, a brake 252, a reduction gear (not shown) that reduces the driving force of the motor 251, and an encoder 253 that detects the rotation angle or the angular velocity of a rotation shaft of the motor 251 or the reduction gear.

The drive section 26 is built into the housing 230 of the second arm 23, and includes a motor 261 that generates a driving force, a brake 262, a reduction gear (not shown) that reduces the driving force of the motor 261, and an encoder 263 that detects the rotation angle or the angular velocity of a rotation shaft of the motor 261 or the reduction gear.

The u-drive section 27 is built into the housing 230 of the second arm 23, and includes a motor 271 that generates a driving force, a brake 272, a reduction gear (not shown) that reduces the driving force of the motor 271, and an encoder 273 that detects the rotation angle or the angular velocity of a rotation shaft of the motor 271 or the reduction gear.

The z-drive section 28 is built into the housing 230 of the second arm 23, and includes a motor 281 that generates a driving force, a brake 282, a reduction gear (not shown) that reduces the driving force of the motor 281, and an encoder 283 that detects the rotation angle or the angular velocity of a rotation shaft of the motor 281 or the reduction gear.

For example, servo motors such as AC servo motors and DC servo motors can be used as the motors 251, 261, 271, and 281. Further, for example, a planetary gear type reduction gear, a strain wave gearing device, or the like can be used as the reduction gears.

The brake 252, the brake 262, the brake 272, and the brake 282 function to decelerate or hold the robotic arm 20. Specifically, the brake 252 reduces the operation speed of the first arm 22, the brake 262 reduces the operation speed of the second arm 23, the brake 272 reduces the operation speed of the third arm 24 in the u-direction, and the brake 282 reduces the operation speed of the third arm 24 in the z-axis direction.

The control device 8 decelerates each part of the robotic arm 20 by changing the energization condition. The brake 252, the brake 262, the brake 272, and the brake 282 are controlled independently of the motor 251, the motor 261, the motor 271, and the motor 281 by the control device 8. In other words, the turning on and off of power to the motor 251, the motor 261, the motor 271, and the motor 281 is not linked to the turning on and off of power to the brake 252, the brake 262, the brake 272, and the brake 282.

Examples of the brakes 252, 262, 272, and 282 include an electromagnetic brake, mechanical brakes, hydraulic brakes, and pneumatic brakes and like.

As shown in FIG. 2, the encoder 253, the encoder 263, the encoder 273, and the encoder 283 are position detection sections that detect the position of the robotic arm 20. The encoders 253, 263, 273, and 283 are electrically connected to the control device 8. The encoder 253, the encoder 263, the encoder 273, and the encoder 283 transmit information about the detected rotation angle or angular velocity as electric signals to the control device 8. This allows the control device 8 to control the operation of the robotic arm 20 based on the received information about the rotation angle or the angular velocity.

The drive section 25, the drive section 26, the u-drive section 27, and the z-drive section 28 are connected to corresponding motor drivers, which are not shown in the drawings, and are controlled by the control device 8 via the motor drivers.

The base 21 is fixed to a floor, for example, by bolts or the like, not shown. The first arm 22 is connected to an upper end portion of the base 21. The first arm 22 is rotatable with respect to the base 21 about a first axis O1 along the vertical direction. When the drive section 25 that rotates the first arm 22 is driven, the first arm 22 rotates with respect to the base 21 in the horizontal plane around the first axis O1. In addition, the rotation amount of the first arm 22 with respect to the base 21 can be detected by the encoder 253.

A second arm 23 is connected to a tip end portion of the first arm 22. The second arm 23 is rotatable with respect to the first arm 22 about a second axis O2 along the vertical direction. The axial direction of the first axis O1 is identical to the axial direction of the second axis O2. That is, the second axis O2 is parallel to the first axis O1. When the drive section 26 that rotates the second arm 23 is driven, the second arm 23 rotates with respect to the first arm 22 in a horizontal plane about the second axis O2. In addition, the encoder 263 can detect a driving amount of the second arm 23 with respect to the first arm 22, specifically, a rotation amount.

The third arm 24 is installed and supported at a tip end portion of the second arm 23. The third arm 24 has a shaft 241. The shaft 241 is rotatable about third axis O3 along the vertical direction and movable in the up-down direction with respect to the second arm 23. The shaft 241 is the most tip end arm of the robotic arm 20.

When the u-drive section 27 that rotates the shaft 241 is driven, the shaft 241 rotates around the u-axis. The rotation amount of the shaft 241 with respect to the second arm 23 can be detected by the encoder 273.

When the z-drive section 28 that moves the shaft 241 in the z-axis direction is driven, the shaft 241 moves in the up-down direction, that is, in the z-axis direction. The encoder 283 detects the movement amount of the shaft 241 in the z-axis direction with respect to the second arm 23.

In the robot 2, the tip end of the shaft 241 is assumed to be a control point TCP and a tip coordinate system is set with this control point TCP is set as the origin. This tip coordinate system has already been calibrated with the robot coordinate system described above, and the position in the tip coordinate system can be converted into the robot coordinate system. Thus, the position of the control point TCP can be specified in the robot coordinate system. In the robotic system 100, the position of the control point TCP can be used as a reference for control by knowing the position of the control point TCP in the robot coordinate system. The robot coordinate system is a coordinate system set for the robot 2, for example, with the origin at an arbitrary point set on the base 21.

Various end effectors 7 can be attached to and detached from the lower end portion of the shaft 241. The end effector 7, in the configuration shown in the figure, is a hand that grips a workpiece W, which is the work object. However, it is not limited to this configuration. For example, it may be a hand that grips a workpiece W by suction or attraction, a tool such as a screwdriver or wrench, or an applicator tool such as a sprayer.

As shown in FIG. 1, the force detection section 5 detects a force applied to the robot 2, that is, a force applied to the robotic arm 20 and the base 21. In this embodiment, the force detection section 5 is provided on the shaft 241 and is capable of detecting a force applied to the shaft 241.

The location of the force detection section 5 is not limited to the above, and may be, for example, the lower end portion of the shaft 241 or each joint portion.

The force detection section 5 can be composed of, for example, a piezoelectric element made of quartz crystal and the like, and can be configured by a plurality of elements that output an electric charge when an external force is applied. The control device 8 can convert this amount of electric charge into a value corresponding to the external force received by the robotic arm 20. The direction of the electric charge that can be generated by such piezoelectric elements when an external force is applied, can be adjusted depending on the direction in which the piezoelectric materials are installed.

Next, the inertial sensor 11 and the inertial sensor 12 will be described. Since the configuration of these sensors are the same except for whether the setting of the detection direction of vibration in use is for a horizontal or vertical direction, the inertial sensor 11 will be described as a representative example. The inertial sensor 12 is used for vibration damping control of the robotic arm 20.

The inertial sensor 11 acquires position information of the robotic arm 20 while the robotic arm 20 is moving and while damped vibration occurs between when the robotic arm 20 is stopped and when it comes to rest. The inertial sensor 11 is configured by a gyro sensor that detects vibration in this embodiment. However, the configuration is not limited thereto, and an inertial measurement unit (IMU) that detects angular velocity and acceleration may be used as the inertial sensor 11.

The inertial sensor 11 is electrically connected to the control section 81, and information on vibration acquired by the inertial sensor 11 is transmitted to the control section 81. Based on this information, the control section 81 identifies the position of the robotic arm 20, that is, the vibration information of the control point TCP.

The vibration information of the control point TCP that the control section 81 identifies from the information acquired from the inertial sensor 11 is the vibration in the robot coordinate system.

The information acquired by the inertial sensor 12 is used for vibration damping control. In other words, while the robotic arm 20 is being driven, the motor drive signal can be generated based on the detection result of the inertial sensor 12 to reduce the detected value. This enables excellent vibration damping control.

As shown in FIGS. 2 and 3, the shape information acquisition section 13 has a light emitting section 131 that emits laser beam L toward a workpiece W, and a light receiving section 132 that receives reflected light LL reflected by the object. The light emitting section 131 is electrically connected to the control section 81, and the light emitting timing and the intensity of the laser beam L are controlled by the control section 81. The light receiving section 132 is electrically connected to the control section 81, and information on the light amount of the reflected light LL received by the light receiving section 132 is transmitted to the control section 81.

The control section 81 acquires the shape information of the object based on the time difference between the time when the light emitting section 131 emits the laser beam L and the time when the light receiving section 132 receives the reflected light LL. Specifically, as shown in FIG. 3, by acquiring information on time differences between light emission and light reception at multiple different positions in the horizontal direction, the shape information of the workpiece W and the information on the position and orientation of the workpiece W can be obtained. If the shape information of the workpiece W is registered in advance, the shape information acquisition section 13 acquires information on the position and the posture of the workpiece W.

A sensor coordinate system is set in the shape information acquisition section 13. The position and the posture of the workpiece W that the control section 81 identifies from the shape information acquired from the shape information acquisition section 13 are the position and the posture in the sensor coordinate system. By mapping the aforementioned robot coordinate system to the sensor coordinate system, the position and posture of the workpiece W, which is identified from the shape information acquired from the shape information acquisition section 13, can be ascertained in the robot coordinate system. Therefore, the robotic arm 20 can perform work on the workpiece W.

Further, as shown in FIG. 4, the shape information acquisition section 13 has the light emitting section 131 that emits a plurality of laser beams L radially. This allows, for example, a narrower pitch of each laser beam L at the position P1, which is lower than the position P2, to increase resolution. At position P2, the pitch of each laser beam L at the position P2 is wider than that at P1, and the laser beam L can be irradiated over a wide region as a whole.

According to such a configuration, for example, when performing delicate work that requires high resolution or work on a workpiece W with a complex shape, the shape information is acquired by moving the robotic arm 20 so that the workpiece W is positioned relatively close to it. Further, for example, when the workpiece W is relatively large or a plurality of workpieces W are arranged over a wide region, the shape information is acquired by moving the robotic arm 20 so that the workpiece W is positioned relatively far away from the robotic arm 20. In this manner, by controlling the robotic arm 20 to position it at the appropriate height as needed, appropriate shape information can be obtained.

The shape information acquisition section 13 has a higher resolution as the distance to the workpiece W, an example of an object, becomes shorter. This allows appropriate shape information to be acquired by controlling the robotic arm 20 to position it at the appropriate height as needed. This has advantages in terms of both time and the image to be detected, since no lens focus manipulation is required during image processing and the CCD camera does not cause image distortion due to vibration when moving in the z-direction.

In this embodiment, the shape information acquisition section 13 is installed in the third arm 24. However, the configuration is not limited thereto, and the shape information acquisition section 13 may be installed in the second arm 23 or the end effector 7.

As described above, the shape information acquisition section 13 and the inertial sensor 11 are installed in the robotic arm 20. This allows to acquire more accurate shape information and position information.

Next, the teaching device 3 will be explained. As shown in FIG. 2, the teaching device 3 has a function of specifying an operation program for the robot 2.

As shown in FIG. 2, the teaching device 3 has a control section 31 comprising a central processing unit (CPU) or the like, a storage section 32, a communication section 33, and a display section 34. The teaching device 3 is not particularly limited, and examples thereof include a tablet, a personal computer, and a smartphone.

The control section 31 reads various programs stored in the storage section 32 and executes the programs. The signal generated by the control section 31 is transmitted to the control device 8 of the robot 2 via the communication section 33. This allows the robotic arm 20 to perform a predetermined operation under a predetermined condition.

The storage section 32 stores various programs and the like, executable by the control section 31. The storage section 32 includes, for example, volatile memory such as random access memory (RAM), non-volatile memory such as read only memory (ROM), and removable external storage devices.

The communication section 33 transmits and receives signals to and from the control device 8 using an external interface such as a wired local area network (LAN) or a wireless LAN.

The display section 34 is configured from various types of displays. In this embodiment, the display section 34 is described as having both display and input operation function, for example, a touch panel type display.

However, it is not limited to this configuration, and may be equipped with a separate input operation section. In this case, the input operation section includes, for examples, a mouse, a keyboard, and the like. It may also be configured to use a touch panel together with a mouse and a keyboard.

Next, the control device 8 will be explained. As shown in FIG. 1, the control device 8 is built into the base 21 in this embodiment. However, it is not limited to this configuration, and may be installed at a location away from the robot 2. The control device 8 has a function of controlling the drive of the robot 1, and is electrically connected to each section of the robot 2 described above. The control device 8 includes a control section 81, a storage section 82, and a communication section 83. These sections are connected to each other, for example, via a bus, so that they can communicate with each other.

The control section 81 is configured from at least one processor, such as a central processing unit (CPU), for example, and reads and executes various programs such as operation programs stored in the storage section 82. Signals generated by the control section 81 are transmitted to and received from each section of the robot 2 via the communication section 83. This allows the robotic arm 20 to perform a predetermined operation under a predetermined condition.

Specifically, as described above, the control section 81 has a processor that controls the drive of the robotic arm 20, a processor that identifies the position and the posture of the workpiece W based on the vibration information acquired by the inertial sensors 11 and 12 that acquire the position information of the robotic arm 20 and based on the shape information acquired by the shape information acquisition section 13, and a processor that performs the vibration damping control based on the vibration information acquired by the inertial sensors 11 and 12.

The storage section 82 stores various programs and the like that can be executed by the control section 81. The storage section 82 includes, for example, volatile memory such as random access memory (RAM), non-volatile memory such as read only memory (ROM), and removable external storage devices.

The communication section 83 transmits and receives a signal to and from each section of the robot 2 or the teaching device 3 using an external interface such as a wired local area network (LAN) or a wireless LAN.

In such a robotic system 100, a servo mechanism is used to drive each motor. In other words, during the driving of each motor, the control section 81 generates drive signals by feeding back the rotation angle or angular velocity information from each encoder to the motor drive signals. Further, it generates drive signals by feeding back the vibration information acquired by the inertial sensors 11 and 12 to the motor drive signals. These feedback controls allow the robotic arm 20 to be driven at high speed and with high accuracy. In such feedback controls, each motor generates vibration due to the combined inertia moment which is caused by the arm's dead weight and its acceleration or stopping from a constant velocity motion state. Therefore, damped vibration occurs even after the robotic arm 20 reaches the target position. As shown in FIG. 5, from the start of the movement of the robotic arm 20 (time T1), the speed increases toward the target position, and when the target position is approached, the speed is controlled to decrease and stop at the target position. Then, damped vibration occurs, and the movement is completed (time T3) when the damped vibration converges. In other words, from “arrival (time T2)” to “completion (time T3)” in FIG. 5, there is time in which damped vibration occurs in the robotic arm 20.

In the related art, as shown in the timing chart on the upper side of FIG. 6, the workpiece W is recognized and work is executed after “movement (time T1 to time T2)” and “damped vibration”. In the present disclosure, as shown in the timing chart on the lower side of FIG. 6, the total drive time of the robotic arm 20 can be reduced by performing a first control to recognize the workpiece during the damped vibration (time T2 to time T3). This will be explained below.

During the damped vibration, the control point TCP draws a spiral trajectory in the xy-plane, as shown in FIG. 7. That is, it passes through a point A1, a point A2, a point A3, a point A4, a point A5, a point A6, a point A7, a point A8, and a point A9 in this order, toward damped vibration contraction. Note that this is an example and the damped vibration does not necessarily follow the trajectory shown in the figure.

The robotic system 100 acquires the shape information from the shape information acquisition section 13 at point A1, point A2, point A3, point A4, point A5, point A6, point A7, point A8, point, and point A9. That is, at each of points A1 to A9, information about the time difference between emitting the laser beam L and receiving the reflected light LL reflected by the workpiece W is acquired. In this case, the laser beam L is irradiated in a grid pattern, and the reflected light LL in the grid pattern is received (see FIG. 8). In FIG. 8, the “1st” image shows the reflected light LL received at point A1, the “2nd” image shows the reflected light LL received at point A2, the “3rd” image shows the reflected light LL received at point A3, the “4th” image shows the reflected light LL received at point A4, the “5th” image shows the reflected light LL received at point A5, the “6th” image shows the reflected light LL received at point A6, the “7th” image shows the reflected light LL received at point A7, the “8th” image shows the reflected light LL received at point A8, and the “final” image shows the reflected light LL received at point A9. For ease of understanding, the workpiece W is not shown in the image in FIG. 8, but information on the time difference is obtained for each dot of reflected light LL. This allows the shape information of the workpiece W to be acquired in each image.

These images are acquired in a misaligned position in the sensor coordinate system described above. Therefore, the control section 81 links the “1st” information obtained at point A1 with the position information of point A obtained from the inertial sensors 11 and 12, links the “2nd” information obtained at point A2 with the position information of point A obtained from the inertial sensors 11 and 12, links the “3rd” information obtained at point A3 with the position information of point A obtained from the inertial sensors 11 and 12, links the “4th” information obtained at point A4 with the position information of point A obtained from the inertial sensors 11 and 12, links the “5th” information obtained at point A5 with the position information of point A obtained from the inertial sensors 11 and 12, links the “6th” information obtained at point A6 with the position information of point A obtained from the inertial sensors 11 and 12, links the “7th” information obtained at point A7 with the position information of point A obtained from the inertial sensors 11 and 12, links the “8th” information obtained at point A8 with the position information of point A obtained from the inertial sensors 11 and 12, links the “final” information obtained at point A9 with the position information of point A obtained from the inertial sensors 11 and 12. Then, by combining the images, the image shown in FIG. 9 is obtained.

With this first control, the position and posture of workpiece W can be more precisely identified from multiple sets of shape information of the workpiece W acquired at different positions in the three dimensional shape of the workpiece W, including the xy-plane and the z direction. As a result, more accurate information on the position and the posture of the workpiece W can be obtained compared to the configuration in which the workpiece W is recognized at a single location after the damped vibration has converged, and better picking locations, including slopes, can also be identified. In particular, the present disclosure performs the first control to acquire shape information, by using the damped vibration that inevitably occurs in the above feedback control, that is, by using the positional shift of the robotic arm 20 during the damped vibration. Therefore, the total time required for the work can be reduced, and accurate object information of the workpiece W can be obtained. As a result, the work can be performed accurately and quickly.

As described above, the robotic system 100 includes the robotic arm 20; the light emitting section 131 that emits the laser beam L toward the workpiece W as an example of an object; the light receiving section 132 that receives the reflected light LL as the laser beam L reflected by the workpiece W; the shape information acquisition section 13 that acquires the shape information of the workpiece W based on time differences between the time when the light emitting section 131 emits the laser beam L and the time when the light receiving section 132 receives the reflected light LL; the inertial sensors 11 and 12 that acquire position information of the robotic arm 20 during damped vibration when the moving robotic arm 20 becomes stationary; and the control section 81 that identifies the position and the posture of the workpiece W based on the shape information and the position information. During damped vibration of the robotic arm 20, the control section 81 performs the first control to identify the position and the posture of the workpiece W based on the shape information and the position information at a first time (for example, at point A1) and the shape information and the position information at a second time (for example, at point A2) after the first time. This allows the shape information and the position information to be acquired using the vibration of the robotic arm 20 during the damped vibration. Therefore, the total time required for the operation can be reduced by an amount equivalent to not waiting for damped vibration to converge, and accurate object information of the workpiece W can be obtained. As a result, the work can be performed accurately and quickly.

After performing the first control, the control section 81 performs a second control described below. The first control identifies the relative position and the posture of the workpiece W relative to the robotic arm 20 during damped vibration, as described above. In the second control, as shown in FIG. 9, the images are combined, and the position and the posture of the workpiece W in the robot coordinate system are identified by linking the robotic arm positions in the sensor coordinate system of the images together with the robotic arm positions in the robot coordinate system, which were detected by the inertial sensors 11 and 12, and then the absolute position and the absolute posture are identified. By performing this second control, the absolute position and the absolute posture of the workpiece W can be identified.

The second control may be performed after the damped vibration has completely converged or during the damped vibration, but it is desirable to perform when the amplitude of the damped vibration is below a predetermined value. This enables accurate and quick identification of the position and the posture of the workpiece W in the robot coordinate system.

In this manner, the control section 81 determines the amplitude of the vibration based on the position information from the inertial sensors 11 and 12, and if the amplitude is smaller than a predetermined value, the control section 81 identifies the position and the posture of the workpiece W in an absolute coordinate system that is mapped to a predetermined coordinate system, that is, the robot coordinate system, of the workpiece W, which is an example of an object. This allows the information obtained by the first control to be identified as the position and the posture of the workpiece W by the second control. Thus, work on the workpiece W can be performed more accurately.

The robotic system 100 is equipped with the encoder 253, the encoder 263, the encoder 273, and the encoder 283 that detect the position and the posture of the robot arm 20, and the control section 81 performs vibration damping control on the robotic arm 20 based on the information on the position and the posture of the robotic arm 20 detected by the encoder 253, the encoder 263, the encoder 273, and the encoder 283 during driving of the robotic arm 20. This can further reduce the time during which damped vibration occurs, further reducing the total operation time.

Further, the control section 81 performs the vibration damping control on the robotic arm 20 based on the vibration information detected by the inertial sensors 11 and 12 during driving of the robotic arm 20. This can further reduce the time during which damped vibration occurs, further reducing the total operation time.

In this embodiment, the vibration damping control is performed based on both the information on the position and the posture of the robotic arm 20 detected by the encoder 253, the encoder 263, the encoder 273, and the encoder 283 and the position information detected by the inertial sensors 11 and 12. However, the present embodiment not limited thereto, and the vibration damping control may be performed based on only one of the above sets of information or based on the position information detected by the inertial sensors 11 and 12.

Next, an example of the robot control method according to the present disclosure will be explained with reference to the flowchart shown in FIG. 10.

First, in step S101, movement is started. In other words, the robotic arm 20 starts moving from the start position toward the target position according to a predetermined operation program.

Next, when the robotic arm 20 reaches the target position in step S102, it is counted as N=1 in step S103 and proceeds to step S104, as the first round loop.

In step S104, it is determined whether the vibration has converged and movement has completed. In other words, it determines whether the damped vibration has converged or not. The decision in this step is based on whether the amplitude calculated based on the position information of the inertial sensors 11 and 12 is smaller than a predetermined value. The position information may be obtained not only from the inertial sensor 11, but also from independent encoder information in the composite coordinate system of the encoders 253, 263, 273, and 283, or from both an inertial sensor and an encoder.

If it is determined in step S104 that the movement is not complete, then in step S105, the shape is measured during vibration. That is, shape information is acquired from the shape information acquisition section 13 (see FIG. 8). In step S106, position measurement is performed, that is, position information is obtained from the inertial sensor 11.

Next, in step S107, the shape information is corrected by the displacement amount. In other words, from the position information of the inertial sensor 11, the deviation from the final stop position where the movement is completed is obtained, and this information is linked with the shape information.

Next, in step S108, 3D space N is stored. In other words, the data is stored in the storage section 82, along with the information that it is the 3D space data of the Nth loop.

Next, set N=N+1 in step S109 and return to step S104. In other words, the next loop cycle is started.

On the other hand, if it is determined in step S104 that the movement is complete, that is, that the damped vibration has converged, steps S110 and S111 are executed. In step S110, the shape information is obtained from the shape information acquisition section 13 (see the “final” image in FIG. 8). Position measurement is performed in step S111, that is, after damped vibration convergence, position information from the inertial sensor 11 is acquired. Up to this point is the first control, and thereafter is the second control.

Next, the shape information is corrected in step S112 by the amount of displacement. In other words, the deviation from the final stop position where the movement is completed is understood based on the position information of the inertial sensor 11, and this information is linked with the shape information. In this step, the mapping between the sensor coordinate system and the robot coordinate system is checked.

Next, in step S113, the 3D space N is stored. In other words, data of the absolute position and the absolute posture of the workpiece W in 3D space are stored in the storage section 82. Next, an array of the 3D space 1 to 3D space N is completed in step S114. In other words, as shown in FIG. 9, all data is combined as positions in the absolute coordinate system that is mapped to the robot coordinate system.

By going through these steps, the position and the posture of the workpiece W can be more accurately identified, thus enabling accurate work to be performed on the workpiece W. In addition, as mentioned above, the total time required for the operation can be reduced to the extent that the position and the posture of the workpiece W are identified without waiting for the damped vibration to converge. As described above, the work can be performed accurately and quickly.

In this way, the robot control method is a control method for the robot 2, which includes the robotic arm 20, the emitting section 131 that emits the laser light L toward the workpiece W as an example of an object, the light receiving section 132 that receives the reflected light LL as the laser beam L reflected by the workpiece W, the shape information acquisition section 13 that acquires shape information of the workpiece W based on the time difference between the time when the light emitting section 131 emits the laser beam L and the time when the light receiving section 132 receives the reflected light LL, and the inertial sensor 11 that acquires position information of the robotic arm 20 during damped vibration when the moving robotic arm 20 becomes stationary. During the damped vibration of the robotic arm 20, the robot control method performs the first control to identify the position and the posture of the workpiece W based on the shape information and the position information at the first time (for example, the time at point A1) and the shape information and the position information at the second time (for example, the time at point A2) after the first time. This allows the shape information and the position information to be obtained using the positional displacement of the robotic arm 20 during the damped vibration. Therefore, the total time required for the operation can be reduced by an amount equivalent to not waiting for damped vibration to converge, and accurate object information of the workpiece W can be obtained. As a result, the work can be performed accurately and quickly.

Although the robotic system and the robot control method according to the present disclosure have been described above based on the shown embodiments, the present disclosure is not limited thereto, and the configuration of each section can be replaced with an arbitrary configuration having the same functions. In addition, other optional configuration or process may be added to the robotic system and the robot control method.

What is claimed is:

1. A robotic system comprising:
a robotic arm;
a shape information acquisition section including a light emitting section, which emits a laser beam toward an object, and a light receiving section, which receives reflected light of the laser beam reflected by the object, the shape information acquisition section acquiring shape information of the object based on time difference between time when the laser beam is emitted by the emitting section and time when the reflected light is received by the light receiving section;
an inertial sensor acquiring position information of the robotic arm during damped vibration when the moving robotic arm becomes stationary; and
a control section identifying a position and a posture of the object based on the shape information and the position information, wherein
the control section performs a first control to identify the position and the posture of the object during the damped vibration of the robotic arm, based on the shape information and the position information at a first time and the shape information and the position information at a second time after the first time.

2. The robotic system according to claim 1, wherein:
the shape information acquisition section and the inertial sensor are installed in the robotic arm.

3. The robotic system according to claim 1, wherein:
the control section determines an amplitude of vibration based on the position information from the inertial sensor, and if the amplitude is smaller than a predetermined value, the control section identifies the position and the posture of the object in a predetermined coordinate system.

4. The robotic system according to claim 1, further comprising: an encoder for detecting a position and a posture of the robotic arm, wherein:
the control section performs vibration damping control on the robotic arm based on the information on the position and the posture of the robotic arm detected by the encoder during the drive of the robotic arm.

5. The robotic system according to claim 1, wherein:
the control section performs vibration damping control on the robotic arm based on vibration information detected by the inertial sensor during drive of the robotic arm.

6. The robotic system according to claim 1, wherein:
the resolution of the shape information acquisition section increases as the distance between the shape information acquisition section and the object decreases.

7. A robot control method for a robot including:
a robotic arm;
a shape information acquisition section including a light emitting section, which emits a laser beam toward an object, and a light receiving section, which receives reflected light of the laser beam reflected by the object, the shape information acquisition section acquiring shape information of the object based on time difference between time when the laser beam is emitted by the emitting section and time when the reflected light is received by the light receiving section; and
an inertial sensor acquiring position information of the robotic arm during damped vibration when the moving robotic arm becomes stationary,
the robot control method including
a first control of identifying a position and a posture of the object, during damped vibration of the robotic arm, based on the shape information and the position information at a first time and the shape information and the position information at a second time after the first time.
